(19) United States
(12) Patent Application Publication
(10) Pub. No.: US 2020/0227195 A1
(43) Pub. Date: Jul. 16, 2020

(54) INDUCTIVE PASSIVE COMPONENT

(71) Applicant: OCTEKCONN INCORPORATION, New Taipei City (TW)

(72) Inventor: CHIA-HSIUNG HO, NEW TAIPEI CITY (TW)

(21) Appl. No.: 16/247,719

(22) Filed: Jan. 15, 2019

(51) Int. Cl. H01F 27/24; H01F 3/00; H01F 27/06; H01F 27/36; H01F 27/29

(52) U.S. Cl. CPC H01F 27/24; H01F 3/00; H01F 27/29; H01F 27/365; H01F 27/06

(57) ABSTRACT

The present invention discloses an inductive passive component comprising: an iron core having a winding portion and two supporting portions respectively disposed on two sides of the winding portion; a plurality of insulating adhesive layers disposed on the top surface of each supporting portions in a manner of quantity corresponding to positions; a plurality of electrode layers, each electrode layers is disposed on each insulating adhesive layers respectively; at least one coil is wound around the winding portion and ends of the at least one coil are lapped on the plurality of electrode layers; two adhesive layers are disposed on the bottom surface of each supporting portions respectively; and a magnetic shield is disposed under the iron core and adhered to the two adhesive layers to be affixed to the two supporting portions.

### BACKGROUND

### 1. Technical Field

This disclosure is related to a passive component, particularly an inductive passive component that enables an iron core attaining good insulation effect and to be closely bonded with other structure bodies.

### 2. Description of Related Art

An inductor is a kind of passive electronic component, which is often used in electronic products. It can resist current changes in electronic circuits so that it has functions such as filtering current noise, stabilizing current value in a circuit, reducing electromagnetic interference, power conversion and so on and so forth.

The inductive passive component is mainly composed of an iron core, an electrode layer and a coil. Usually the iron core has a winding portion and supporting portions situated on two sides of the winding portion. The coil is wound around the winding portion and the ends of the coil are lapped with the electrode layers disposed on the supporting portions. However, in the field of the art, the electrode layer is directly disposed on and connected to the top of the supporting portion of the iron core. In this way, when the electrode layer is conducted, the iron core will be subjected to the conducting current directly due to poor insulation effect and may have short-circuited problem with the electrode layer. Furthermore, the electrode layer is liable to problems like fall off due to insufficient bonding strength.

### SUMMARY

In view of the above-mentioned problems of the prior art, the purpose of the present disclosure is to provide an inductive passive component that enable an iron core to attain good insulation effect and to be closely bonded with other structure bodies.

According to the purpose of the present disclosure, an inductive passive component is provided, comprising: an iron core, comprising of a winding portion and two supporting portions, each of the supporting portions respectively disposed on opposite sides of the winding portion and the top surface of the supporting portion being higher than the winding portion; a plurality of insulating adhesive layers respectively disposed on the top surface of each of the supporting portions with intervals in a way of quantity corresponding to positions; a plurality of electrode layers, each of the electrode layers disposed on each of the insulating adhesive layers; at least one coil, being wound around the winding portion and an end of the at least one coil being lapped on the plurality of electrode layers; two adhesive layers, each of the adhesive layers being disposed on a bottom surface of each of the supporting portions; and a magnetic shield disposed under the iron core and the magnetic shield being adhered to the two adhesive layers to be affixed to the two supporting portions.

According to the above feature, the electrode layer may comprise: a silver layer disposed on the insulating adhesive layer; a nickel layer disposed on the silver layer; and an aluminum layer disposed on the nickel layer.

According to the above feature, the electrode layer may be a metal piece.

According to the above feature, the electrode layer is an L-shaped metal piece, one side is adhered to the insulating adhesive layer and another side is adhered to a side facing outward of the supporting portion.

According to the above features, the magnetic shield may be planar.

According to the above feature, the magnetic shield may be U-shaped and the height of two wings of the magnetic shield is half of the height of the supporting portion.

According to the above feature, the magnetic shield may be U-shaped and the height of two wings of the magnetic shield are higher than the supporting portion.

According to the above features, the material of insulating adhesive layer may comprise a hardening adhesive.

According to the above features, the adhesive layer may be made of an insulating magnetic powder comprising a resin and a metal magnetic powder.

According to the above features, material of the metal core may comprise manganese zinc or nickel zinc.

According to the above features, material of the magnetic shield may comprise of manganese zinc or nickel zinc.

According to the above description, the inductive passive component of the present disclosure is provided with insulating adhesive layers between the iron core and the electrode layers. The iron core may attain a good insulating effect through the insulating adhesive layers so the iron core may withstand high voltage and avoid short-circuited with the electrode layers and the iron core is closely bonded to the electrode layers through the insulating adhesive layers. Under the condition of the bonding strength is improved, the problem of the electrode layers being detached from the iron core may be avoided. Furthermore, the present disclosure is provided with a magnetic shield under the iron core which is capable of increasing the electromagnetic induction. The adhesive layers are disposed between the magnetic shield and the iron core. Through the adhesive layers, the iron core and the magnetic shield are bonded closely.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a first schematic diagram of a first embodiment of an inductive passive component of the present disclosure.

FIG. 2 is a second schematic diagram of the first embodiment of the inductive passive component of the present disclosure.

FIG. 3 is a third schematic diagram of the first embodiment of the inductive passive component of the present disclosure.

FIG. 4 is a first schematic diagram of a second embodiment of the inductive passive component of the present disclosure.

FIG. 5 is a second schematic diagram of the second embodiment of the inductive passive component of the present disclosure.

FIG. 6 is a third schematic diagram of the second embodiment of the inductive passive component of the present disclosure.

FIG. 7 is a schematic diagram of a third embodiment of the inductive passive component of the present disclosure.

### DESCRIPTION OF THE EXEMPLARY EMBODIMENTS

To understand the technical features, content and advantages of the present disclosure and its efficacy, the present disclosure will be described in detail with references to the accompanying drawings. The drawings are for illustrative and auxiliary purposes only and may not necessarily be the true scale and precise configuration of the present disclosure. Therefore, the scope of the present disclosure should not be limited to and interpreted as the scale and configuration of the attached drawings.

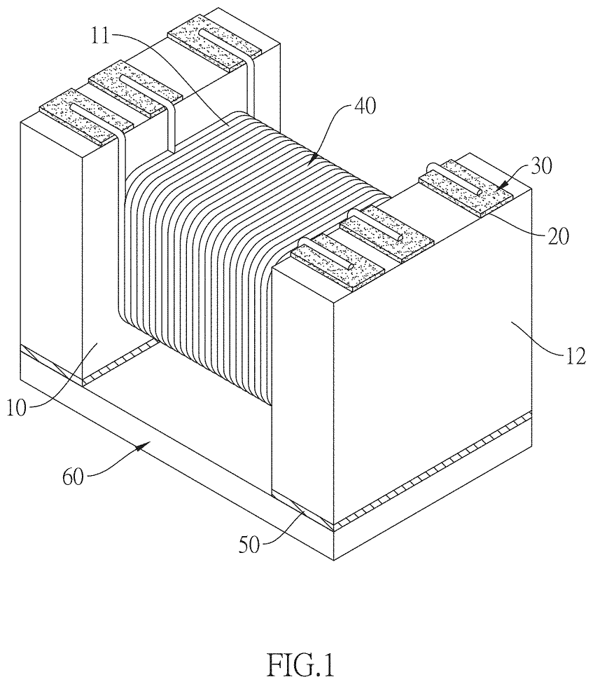

Referring to FIG. 1 to FIG. 3 together, which are the first schematic diagram, the second schematic diagram and the third schematic diagram of the first embodiment of the inductive passive component of the present disclosure. As shown in the diagram, the inductive passive component of the present disclosure comprises a metal core 10, a plurality of insulating adhesive layers 20, a plurality of electrode layers 30, at least one coil 40, two adhesive layers 50 and a magnetic shield 60.

The core 10 comprises a winding portion 11 and two supporting portions 12. Each of the supporting portions 12 is disposed on opposite sides of the winding portion 11 and the top surface of the supporting portion 12 is higher than the winding portion 11 so that the iron core 10 may be but not limited to be in an I-shape. The material of the iron core 10 may comprise manganese zinc or nickel zinc.

The plurality of insulating adhesive layers 20 are respectively disposed on the top surface of each supporting portions 12 of the iron core 10 at intervals in a way of quantity corresponding to positions. As shown in the figure, the top surfaces of the supporting portions 12 are respectively disposed with three insulating adhesive layers 20. The material of the insulating adhesive layer 20 may comprise a hardening adhesive (Epoxy).

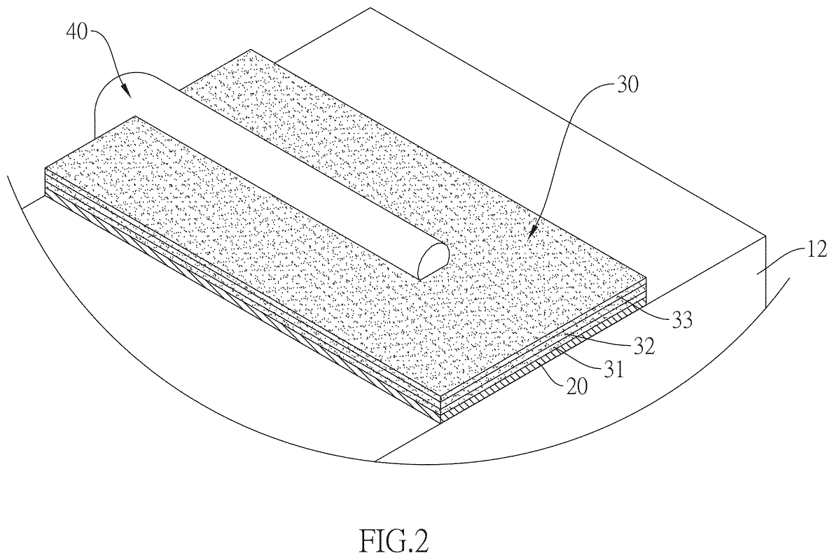

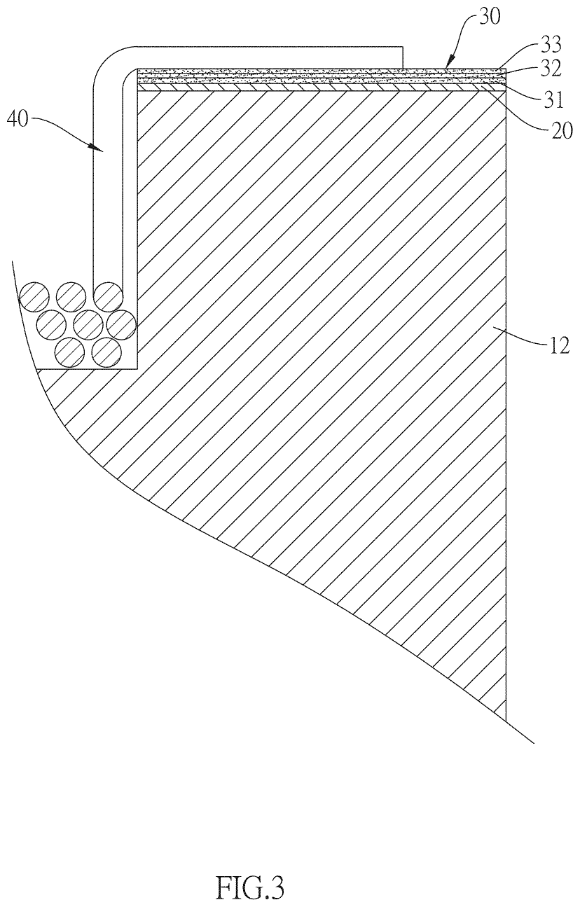

The number of the plurality of electrode layers 30 is corresponding to the number of the plurality of insulating adhesive layers 20, and each electrode layers 30 is disposed on top of each insulating adhesive layers 20 respectively, wherein the shape and size of electrode layer 30 are preferably corresponding to the shape and size of insulating adhesive layer 20. As shown in this embodiment, the electrode layer 30 has and is not limited to be in a rectangular. Furthermore, as shown in FIG. 2 and FIG. 3, the electrode layer 30 of the first embodiment includes a silver layer 31, a nickel layer 32 and an aluminum layer 33 from the bottom to the top sequentially; the silver layer 31 is formed on the insulating adhesive layer 20 by a high temperature baking method of about 700° C. to 800° C. The nickel layer 32 is formed on the silver layer 31 by electroplating and the aluminum layer 33 is formed by electroplating on the nickel layer 32.

The at least one coil 40 is wound around the winding portion 11 of the iron core 10, and the end points of the at least one coil 40 are lapped on the plurality of electrode layers 30 on the top surface of each of the supporting portions 12. Preferably, the end of the coil 40 is affixed to be bent into an L shape along the shape of the supporting portion 12.

Each of the adhesive layers 50 is disposed on a bottom surface of each of the supporting portions 12, wherein the adhesive layer 50 may be made of insulating magnetic powder adhesive comprising a resin and a metal magnetic powder.

The magnetic shield 60 is disposed under the iron core 10 and the magnetic shield 60 is adhered to two adhesive layers 50 to be affixed to the two supporting portions 12. In this embodiment, the magnetic shield 60 may be planar and the material of the magnetic shield 60 may comprise manganese zinc or nickel zinc.

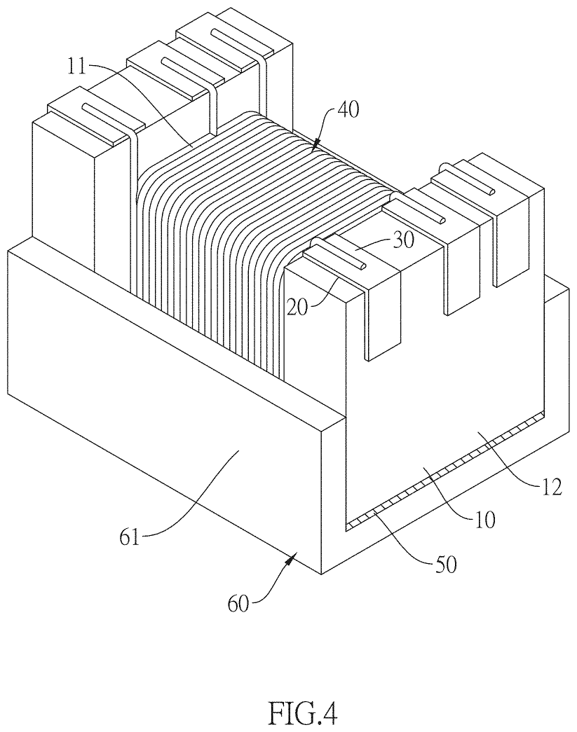

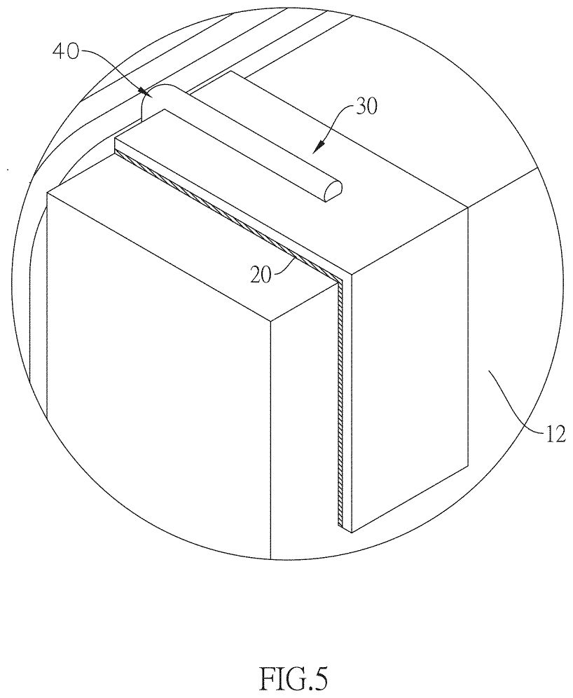

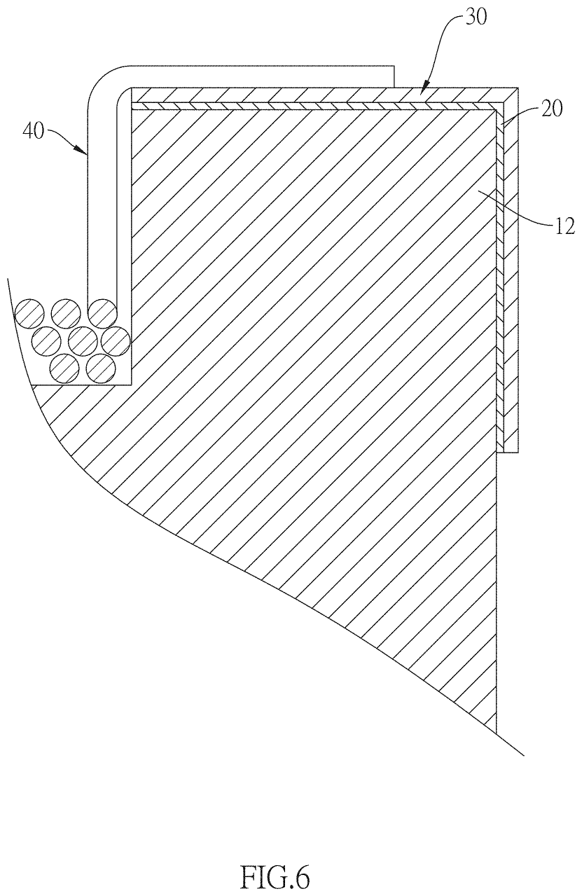

Please refer to FIG. 4 to FIG. 6 together, which are the first schematic diagram, the second schematic diagram and the third schematic diagram of the second embodiment of the inductive passive component of the present disclosure respectively. In the second embodiment, the inductive passive component also includes the iron core 10, the plurality of insulating adhesive layers 20, the plurality of electrode layers 30, the at least one coil 40, the two adhesive layers 50 and the magnetic shield 60. What is different from the first embodiment is that the electrode layer 30 of the inductive passive component is an integrally formed metal piece and the electrode layer 30 is an L-shaped metal piece. One side of the electrode layer 30 is adhered to the insulating adhesive layer 20. The other side of the electrode layer 30 is adhered to the side facing outward of the supporting portion 12. Moreover, the magnetic shield 60 of the embodiment is in U-shape and the height of the two wings 61 of the magnetic shield 60 is half of the height of the supporting portion 12 so that the magnetic shield 60 may cover the winding portion 11 of the iron core 10 in half to increase the amount of electromagnetic induction.

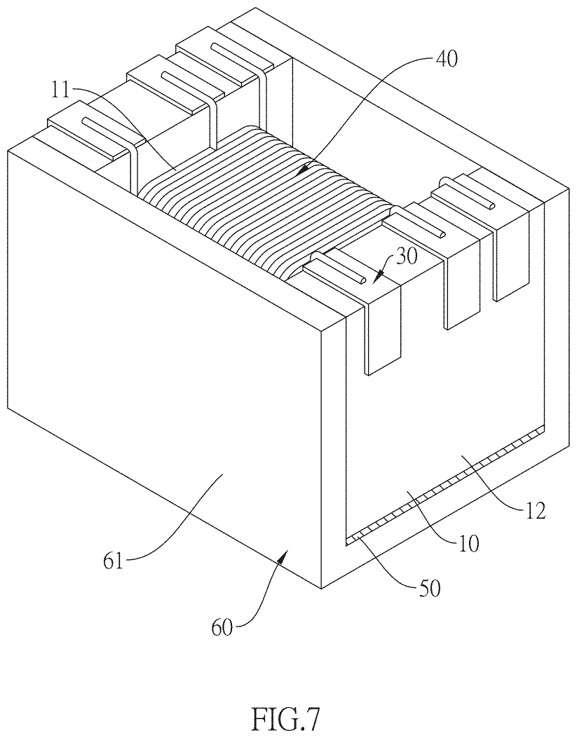

Follow by the third embodiment as shown in FIG. 7, the magnetic shield 60 may also be designed in a manner of U-shape and the two wings 61 of the magnetic shield 60 are higher than the supporting portion 12 so that the magnetic shield 60 may fully cover the winding portion 11 of the iron core 10.

Specifically, the inductive passive component of the present disclosure has the following advantages:

1. An insulating adhesive layer is arranged between the iron core and the electrode layer. Through the insulating adhesive layer, it may make the iron core attaining good insulation effect. When the electrode layer is conducted, the iron core may withstand high voltage and effectively avoid having short circuit with the electrode layer and through the insulating adhesive layer that enables the electrode layer bonded tightly to the iron core, the electrode layer is prevented from detaching off.

2. A magnetic shield is disposed under the iron core. The amount of electromagnetic inductance may be effectively improved through the magnetic shield.

3. An adhesive layer is disposed between the iron core and the magnetic shield. The iron core and the magnetic shield may be firmly bonded through the adhesive layer to improve the bonding strength between the structures.

Overviewing the above description, it may be seen that the present disclosure has attained the desired effect than the prior art, and it is not obvious for person having ordinary skill in the art to think of the same feature. Moreover, the present disclosure has not been disclosed before its application and it is unobvious and industrially applicable. It has been in line with the patent application requirements, therefore the present application is filed according to the law. The allowance of the present utility model application is kindly requested to encourage innovation.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. An inductive passive component, comprising:
an iron core, comprising a winding portion and two supporting portions, each of the supporting portions being disposed on opposite sides of the winding portion and the top surface of the supporting portion being higher than the winding portion;
a plurality of insulating adhesive layers, the plurality of insulating adhesive layers being respectively disposed at a top surface of each of the supporting portions in a way of quantity corresponding to positions;
a plurality of electrode layers, each of the electrode layers being disposed on each of the insulating adhesive layers;
at least one coil being wound around the winding portion and the end of the at least one coil being lapped on the plurality of electrode layers;
two adhesive layers, each of adhesive layers being disposed on a bottom surface of each of the supporting portions;
a magnetic shield being disposed under the iron core and the magnetic shield being adhered to the two adhesive layers to be affixed to the two supporting portions.

2. The inductive passive component according to claim 1, wherein the electrode layer comprises: a silver layer is disposed on the insulating adhesive layer; a nickel layer is disposed on the silver layer; and an aluminum layer is disposed on the nickel layer.

3. The inductive passive component according to claim 1, wherein the electrode layer is a metal piece.

4. The inductive passive component according to claim 3, wherein the electrode layer is an L-shaped metal piece, a side of the electrode layer is adhered to the insulating adhesive layer and another side of the electrode layer is adhered to a side facing outward of the supporting portion.

5. The inductive passive component according to claim 1, wherein the magnetic shield is planar.

6. The inductive passive component according to claim 1, wherein the magnetic shield is U-shaped and height of two wings of the magnetic shield is half of height of the supporting portion.

7. The inductive passive component according to claim 1, wherein the magnetic shield is U-shaped and two wings of the magnetic shield are equal to or higher in height than the supporting portion.

8. The inductive passive component according to claim 1, wherein material of the insulating adhesive layer comprises a hardening adhesive.

9. The inductive passive component according to claim 1, wherein the adhesive layer is made of an insulating magnetic powder comprising a resin and a metal magnetic powder.

10. The inductive passive component according to claim 1, wherein material of the iron core comprises manganese zinc or nickel zinc.

11. The inductive passive component according to claim 1, wherein material of the magnetic shield comprises manganese zinc or nickel zinc.
